(19) United States
(12) Patent Application Publication
(10) Pub. No.: US 2019/0224752 A1
(43) Pub. Date: Jul. 25, 2019

(54) METHOD FOR MANUFACTURING SINTERED COMPONENT

(71) Applicant: Sumitomo Electric Sintered Alloy, Ltd., Takahashi-shi (JP)

(72) Inventor: Yasunori Sonoda, Takahashi-shi (JP)

(21) Appl. No.: 16/315,690

(22) PCT Filed: Dec. 22, 2017
(86) PCT No.: PCT/JP2017/046206

§ 371 Date: Jan. 7, 2019

(30) Foreign Application Priority Data
Mar. 7, 2017 (JP) 2017-043127

(51) Int. Cl. B22F 3/16; B22F 5/10; B23B 35/00

(52) U.S. Cl. CPC B22F 3/162; B23B 35/00; B22F 5/10

(57) ABSTRACT

A method for manufacturing a sintered component includes a compaction step of press-compacting a starting powder containing a metal powder to form a compact; a drilling step of forming a hole in the compact with a drill to form a thin portion where the thickness between an inner circumferential surface of the hole and an outer surface of the compact is smaller than the diameter of the hole; and a sintering step of sintering the compact after the drilling step. The drilling step is performed while the outer surface of the compact is pressed in a region extending over the entire length of the hole in an axial direction. The width of the region where the outer surface of the compact is pressed is from 1/3 times to twice the diameter of the hole.

### TECHNICAL FIELD

The present invention relates to methods for manufacturing sintered components. This application claims priority to Japanese Patent Application No. 2017-043127, filed Mar. 7, 2017, the entire contents of which are incorporated herein by reference.

### BACKGROUND ART

Sintered components disclosed in PTL 1 and PTL 2 are known as sintered components for use in applications such as automotive components and general machinery components. These sintered components are each manufactured by press-compacting a starting powder containing a metal powder, drilling the compact at a predetermined position with a drill, and sintering the drilled compact. In PTL 1, a candle-shaped drill is used for drilling. In PTL 2, a drill including an end portion having an arc-shaped cutting edge (R-drill) is used.

### CITATION LIST

### Patent Literature

PTL 1: Japanese Unexamined Patent Application Publication No. 2016-113658

PTL 2: Japanese Unexamined Patent Application Publication No. 2016-113657

### SUMMARY OF INVENTION

A method for manufacturing a sintered component according to the present disclosure includes:

a compaction step of press-compacting a starting powder containing a metal powder to form a compact;

a drilling step of forming a hole in the compact with a drill to form a thin portion where the thickness between an inner circumferential surface of the hole and an outer surface of the compact is smaller than the diameter of the hole; and

a sintering step of sintering the compact after the drilling step,

wherein the drilling step is performed while the outer surface of the compact is pressed in a region extending over the entire length of the hole in an axial direction, and

wherein the width of the region where the outer surface of the compact is pressed is from 1/3 times to twice the diameter of the hole.

### BRIEF DESCRIPTION OF DRAWINGS

FIG. 1 includes perspective views showing, in outline, a method for manufacturing a sintered component according to an embodiment.

FIG. 2 is a plan view of a compact as viewed in the axial direction of a drill in the method for manufacturing a sintered component according to the embodiment.

FIG. 3A is a schematic plan view illustrating an example of the drill according to the embodiment.

FIG. 3B is a schematic front view of the drill in FIG. 3A as viewed from the end portion thereof

FIG. 3C is a schematic side view partially showing the end portion of the drill in FIG. 3A.

### DESCRIPTION OF EMBODIMENTS

The sintered component in PTL 1 above is formed as a cylinder, and a through-hole is formed between the outer and inner circumferential surfaces of the cylinder near an end surface of the cylinder. This sintered component includes a thin portion where the thickness between the inner circumferential surface of the through-hole and the end surface of the cylinder is smaller than the diameter of the through-hole. The sintered component in PTL 2 is formed as a cylinder, and a through-hole is formed between the outer and inner circumferential surfaces of the cylinder at a position where the distance between the inner circumferential surface of the through-hole and the end surface of the cylinder is larger than or equal to the diameter of the through-hole. These sintered components are each manufactured by press-compacting a starting powder containing a metal powder, drilling the compact at a predetermined position with a drill, and sintering the drilled compact. In PTL 1 above, a candle-shaped drill is used for drilling. In PTL 2 above, a drill including an end portion having an arc-shaped cutting edge (R-drill) is used.

### Technical Problem

The use of a candle-shaped drill tends to reduce the likelihood of cracking in the outer surface of the thin portion even though the unsintered compact has a lower strength (more brittle) than the sintered component. However, even if a candle-shaped drill is used, cracking may occur in the outer surface of the thin portion, depending on the processing conditions.

Accordingly, one object is to provide a method for manufacturing a sintered component without a flaw such as a crack in the outer circumferential surface of a thin portion.

### Advantageous Effects of Invention

The method for manufacturing a sintered component according to the present disclosure allows a sintered component without a flaw such as a crack in the outer circumferential surface of a thin portion to be manufactured with high productivity.

### Description of Embodiments of Invention

First, a list of embodiments of the present invention will be described.

(1) A method for manufacturing a sintered component according to one aspect of the present invention includes:

a compaction step of press-compacting a starting powder containing a metal powder to form a compact;

a drilling step of forming a hole in the compact with a drill to form a thin portion where the thickness between an inner circumferential surface of the hole and an outer surface of the compact is smaller than the diameter of the hole; and

a sintering step of sintering the compact after the drilling step,

wherein the drilling step is performed while the outer surface of the compact is pressed in a region extending over an entire length of the hole in an axial direction, and

wherein the width of the region where the outer surface of the compact is pressed is from 1/3 times to twice the diameter of the hole.

According to the configuration described above, a sintered component without a flaw such as a crack in the outer circumferential surface of a thin portion is obtained. Pressing the outer surface of the compact in the drilling step reduces the widening of the thin portion outward of the hole due to a stress exerted by the drill so as to widen the hole outward. This facilitates formation of a hole without a flaw such as a crack in the compact even though the compact is more brittle than the sintered component. Thus, a compact without a flaw in the outer surface of a thin portion is obtained. Since the surface properties of the sintered component remain substantially the same as the surface properties of the compact, a sintered component without a flaw in the outer surface of a thin portion is obtained by sintering a compact without a flaw in the outer surface of a thin portion. If the width of the region where pressing is performed is not less than 1/3 times the diameter of the hole, a sufficient pressing force can be applied to the outer surface of the compact. If the width is not more than twice the diameter of the hole, no excessive pressing force will act locally on the outer surface of the compact. The width refers to the length in the direction orthogonal to the axial direction of the hole and parallel to the outer surface.

(2) In one embodiment of the method for manufacturing a sintered component, the drill may include an end portion having an arc-shaped cutting edge.

According to the configuration described above, the use of a drill including an end portion having an arc-shaped cutting edge to form a through-hole in the compact reduces the likelihood of edge chipping, i.e., chipping at the edge of the exit of the hole. Edge chipping occurs when the bottom of the hole comes off, rather than is cut by the drill, and the area near the bottom collapses together. Since the above drill has an arc-shaped cutting edge, the thrust load itself is low, and the thrust load acting on the bottom of the hole is dispersed and therefore causes little stress concentration. Thus, the compact can be cut immediately before the drill penetrates the compact, so that the likelihood of the bottom of the hole collapsing before the drill penetrates the compact can be reduced. “Arc-shaped cutting edge” will be described in detail later.

### Details of Embodiments of Invention

Details of embodiments of the present invention will hereinafter be described with reference to the drawings, in which the same reference characters designate parts with the same names.

[Method for Manufacturing Sintered Component]

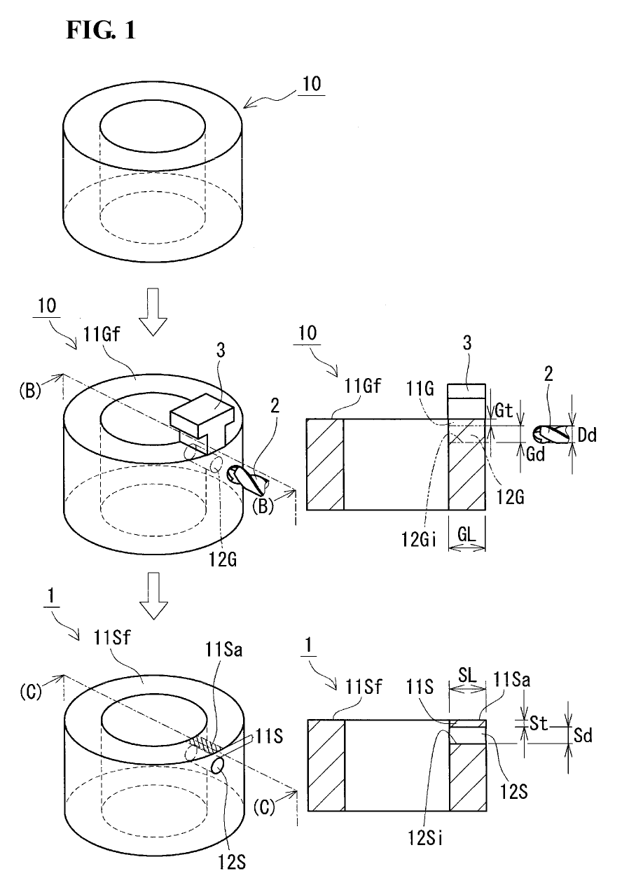

A method for manufacturing a sintered component according to an embodiment includes a compaction step of forming a compact, a drilling step of forming a through-hole in the compact, and a sintering step of sintering the compact after the drilling step. One of the features of this method for manufacturing a sintered component is that, in the drilling step, a hole is formed at a predetermined position to form a predetermined thin portion while a particular surface other than the work surface where the hole is to be formed is pressed at a particular position. The individual steps will hereinafter be described in detail with reference to FIG. 1 where appropriate.

[Compaction Step]

In the compaction step, a starting powder containing a plurality of metal particles is press-compacted to form a compact. This compact serves as a raw material for the mechanical component to be produced through sintering, described later.

(Starting Powder)

The starting powder mainly contains a metal powder containing a plurality of metal particles. The material of the metal powder may be appropriately selected depending on the material of the sintered component to be manufactured, typically an iron-based material.

The iron-based material refers to iron and iron alloys containing iron as a major constituent. Examples of iron alloys include those containing one or more additive elements selected from Ni, Cu, Cr, Mo, Mn, C, Si, Al, P, B, N, and Co. Specific iron alloys include stainless steel, Fe—C-based alloys, Fe—Cu—Ni—Mo-based alloys, Fe—Ni—Mo—Mn-based alloys, Fe—P-based alloys, Fe—Cu-based alloys, Fe—Cu—C-based alloys, Fe—Cu—Mo-based alloys, Fe—Ni—Mo—Cu—C-based alloys, Fe—Ni—Cu-based alloys, Fe—Ni—Mo—C-based alloys, Fe—Ni—Cr-based alloys, Fe—Ni—Mo—Cr-based alloys, Fe—Cr-based alloys, Fe—Mo—Cr-based alloys, Fe—Cr—C-based alloys, Fe—Ni—C-based alloys, and Fe—Mo—Mn—Cr—C-based alloys. A starting powder mainly containing an iron-based material powder can be used to obtain an iron-based sintered component. If the starting powder mainly contains an iron-based material powder, the iron-based material powder may be present in an amount of, for example, 90% by mass or more, or 95% by mass or more, with the amount of the starting powder being 100% by mass.

If the starting powder mainly contains an iron-based material powder, particularly iron powder, metal powders such as Cu, Ni, and Mo may be added as alloying constituents. Cu, Ni, and Mo, which are elements that improve the hardenability, may be added in an amount of, for example, from more than 0% by mass to 5% by mass, or from 0.1% by mass to 2% by mass, with the amount of the starting powder being 100% by mass. Nonmetallic inorganic materials such as carbon (graphite) powder may also be added. C, which is an element that improves the strength of the sintered compact or that subjected to heat treatment, may be added in an amount of, for example, from more than 0% by mass to 2% by mass, or from 0.1% by mass to 1% by mass, with the amount of the starting powder being 100% by mass.

The starting powder preferably contains a lubricant. If the starting powder contains a lubricant, the lubricant increases the lubricity during compaction and therefore improves the compactability when the starting powder is press-compacted to form a compact. Thus, a dense compact tends to be obtained even if the pressure for press compaction is reduced, and a high-density sintered component tends to be obtained by increasing the density of the compact. In addition, if the starting powder is mixed with a lubricant, the lubricant is dispersed throughout the compact and therefore also functions as a lubricant for a cutting tool when the compact is cut with a cutting tool in a later step. Thus, the cutting resistance can be reduced, and the tool life can be improved.

Examples of lubricants include metallic soaps such as zinc stearate and lithium stearate; fatty acid amides such as stearamide; and higher fatty acid amides such as ethylenebisstearamide. The lubricant may be in any form, such as a solid, powder, or liquid form. The lubricant may be present in an amount of, for example, 2% by mass or less, or 1% by mass or less, with the amount of the starting powder being 100% by mass. If the lubricant is present in an amount of 2% by mass or less, the compact contains a high proportion of metal powder. Thus, a dense, high-strength compact tends to be obtained even if the pressure for press compaction is reduced. In addition, the volume contraction due to loss of lubricant can be reduced when the compact is sintered in a later step; therefore, a sintered component with high density and high dimensional accuracy tends to be obtained. To achieve the lubricity-improving effect, the lubricant is preferably present in an amount of 0.1% by mass or more, or 0.5% by mass or more.

The starting powder contains no organic binder. Since the starting powder contains no organic binder, the compact contains a high proportion of metal powder. Thus, a dense compact tends to be obtained even if the pressure for press compaction is reduced. In addition, the compact needs no debinding in a later step.

The starting powder mainly contains the metal powder described above and may contain incidental impurities.

The metal powder described above may be, for example, a water-atomized powder, a reduced powder, or a gas-atomized powder. Particularly suitable are water-atomized powders and reduced powders. Since water-atomized powders and reduced powders have many irregularities on the surfaces of the particles, these irregularities on the particles mesh with each other during compaction, thus increasing the shape-retaining ability of the compact. In general, particles with fewer surface irregularities tend to be obtained for gas-atomized powders, whereas particles with more surface irregularities tend to be obtained for water-atomized powders and reduced powders.

The metal powder may have an average particle size of, for example, 20 μm or more, or from 50 μm to 150 μm. The average particle size of the metal powder refers to the particle size where the cumulative volume is 50% in the volume particle size distribution measured with a laser diffraction particle size distribution analyzer (hereinafter referred to as D50). A metal powder having an average particle size within the above range is easy to handle and press-compact.

(Press Compaction)

Press Compaction is performed with an appropriate compaction apparatus (compaction mold) capable of compaction into the shape corresponding to the final shape of the mechanical component. Mechanical components are often cylindrical with a circular bore formed in the center thereof. Such cylindrical mechanical components are fabricated by press compaction in the axial direction of the cylinder. Some mechanical components have a through-hole (e.g., for use as an oil hole) formed so as to extend from the outer circumferential surface thereof in the direction orthogonal to the bore. This through-hole cannot be integrally formed during the formation of the compact; therefore, it is formed in the drilling step described later.

Here, as shown in the upper and middle parts of FIG. 1, a compact 10 is cylindrical for illustration purposes. This compact 10 can be formed, for example, with upper and lower punches having annular press surfaces that form both end surfaces of the compact 10, a cylindrical core rod that is inserted inside the upper and lower punches and that forms the inner circumferential surface of the compact 10, and a die surrounding the periphery of the upper and lower punches and having formed therein a circular insertion hole that forms the outer circumferential surface of the compact 10. Both end surfaces of the compact 10 in the axial direction are the pressed surfaces pressed by the upper and lower punches. The inner and outer circumferential surfaces are the surfaces brought into sliding contact with the die. The bore is integrally formed during compaction.

The pressure for press compaction may be, for example, from 250 MPa to 800 MPa.

[Drilling Step]

In the drilling step, a hole 12G is formed in the compact 10 with a drill 2 to form a thin portion 11G (the middle part of FIG. 1). The hole 12G is a through-hole or a blind hole; here, the hole 12G is a through-hole. The work surfaces in this example are the outer and inner circumferential surfaces of the compact 10, and drilling is performed from the outer circumferential surface toward the central axis of the compact 10. The thin portion 11G refers to a portion that is formed between the inner circumferential surface 12Gi of the hole 12G and the outer surface 11Gf (end surface) of the compact 10 and where the thickness Gt between the inner circumferential surface 12Gi of the hole 12G and the outer surface 11Gf of the compact 10 is smaller than the diameter Gd of the hole 12G (the diameter Dd of the drill 2) (the sectional view on the right of the middle part of FIG. 1). The thickness Gt refers to the shortest length between the inner circumferential surface 12Gi of the hole 12G and the outer surface 11Gf of the compact 10. That is, the hole 12G is formed in the drilling step at a position where the thickness Gt of the thin portion 11G formed by the formation of the hole 12G is smaller than the diameter Gd of the hole 12G. The compact 10 shown in the middle part of FIG. 1 is a cylinder before the formation of the thin portion 11G and the hole 12G, which are indicated by two-dot chain lines. The sectional view of the compact 10 on the right of the middle part of FIG. 1 is a sectional view taken along line (B)-(B) in the overall perspective view on the left of the middle part of the same figure.

The thickness Gt of the thin portion 11G is preferably from Gd/5 to Gd/2 (from Dd/5 to Dd/2). If the thickness Gt of the thin portion 11G falls within the above range, the likelihood of damage to the outer surface of the thin portion 11G can be reduced. The outer surface of the thin portion 11G refers to the region of the outer surface 11Gf (end surface) of the compact 10 where the hole 12G is projected in the axial direction of the compact 10. The thickness Gt of the thin portion 11G may be, for example, from 0.01 mm to 10 mm, or from 0.5 mm to 10 mm, depending on the diameter Gd of the hole 12G.

The surface properties of the outer surface of the thin portion 11G remain substantially the same as those immediately after press compaction. This is because, as described above, the likelihood of damage to the outer surface of the thin portion 11G tends to be reduced when the compact 10 is drilled. The surface properties of the outer surface of the thin portion 11G also remain substantially the same after sintering, described later.

In view of the fact that a sintered component 1 (the lower part of FIG. 1) becomes smaller in size than the compact 10 after the sintering of the compact 10, the diameter Gd of the hole 12G (the diameter Dd of the drill 2) may be appropriately selected so that the diameter Sd of the hole 12S of the sintered component 1 falls within a predetermined range. The diameter Gd of the hole 12G (the diameter Dd of the drill 2) may be, for example, from 0.2 mm to 50 mm.

The length GL of the hole 12G in the axial direction may be larger than or equal to the diameter Gd of the hole 12G (the diameter Dd of the drill 2). The advantages described above, including reduced likelihood of damage to the outer surface of the thin portion 11G, improved productivity, and reduced decrease in the life of the drill 2, can be achieved even if the length GL of the hole 12G to be formed is long, i.e., larger than or equal to the diameter Gd of the hole 12G (the diameter Dd of the drill 2). The length GL of the hole 12G may be 2 Gd (2 Dd) or more, particularly 3 Gd (3 Dd) or more. The length GL of the hole 12G may be about 15 Gd (15 Dd) or less.

Drilling is performed while the outer surface 11Gf (end surface) of the compact 10 is pressed. In this way, a compact 10 without a flaw in the outer surface of the thin portion 11G is obtained. This is because pressing the outer surface 11Gf of the compact 10 during drilling reduces the widening of the thin portion 11G outward due to a stress exerted by the drill 2 so as to widen the hole 12G outward. The surface to be pressed is a surface other than the work surface to be drilled (the outer circumferential surface of the compact 10); here, it is the outer surface 11Gf (end surface) adjacent to the outer circumferential surface of the compact 10. The region where pressing is performed may be a region of the outer surface 11Gf of the compact 10 extending over the entire length of the hole 12G in the axial direction. This allows the compact 10 to be fabricated without a flaw in the outer surface of the thin portion 11G over the entire length of the hole 12G in the axial direction.

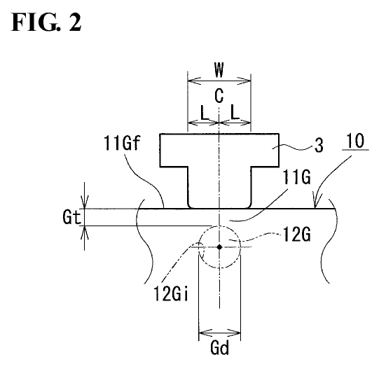

Pressing may be performed with a pressing member 3 (FIG. 2) that presses a predetermined region of the outer surface 11Gf of the compact 10 and a load-applying mechanism (not shown) that applies a predetermined load to the pressing member 3. FIG. 2 is a plan view of the compact 10 as viewed in the axial direction of the drill 2 (the middle part of FIG. 1). The pressing member 3 has a pressing surface that presses the compact 10 and a load-receiving surface that is located opposite the pressing surface and that receives the load from the load-applying mechanism. Although the pressing member 3 may have a cross-sectional shape such as a rectangular shape, with the pressing surface and the load-receiving surface having the same width, the pressing member 3 preferably has a shape such as a T-shape or an inverted trapezoidal shape, with the load-receiving surface being wider than the pressing surface. This allows the load-applying mechanism to easily apply a load to the pressing member 3 and thus allows the pressing member 3 to easily apply a pressing force to the outer surface 11Gf of the compact 10. Here, the cross-sectional shape of the pressing member 3 is a T-shape. In the surface of the pressing member 3 that comes into contact with the outer surface 11Gf of the compact 10, the corners of the pressing member 3 are preferably round-chamfered. This reduces the likelihood of the corners of the pressing member 3 damaging the outer surface 11Gf of the compact 10 when the pressing member 3 presses the outer surface 11Gf of the compact 10. In FIG. 2, the round chamfers at the corners are exaggerated for illustration purposes. Examples of load-applying mechanisms that can be used include hydraulic cylinders and electric cylinders. Alternatively, a weight may be placed on the pressing member 3 to apply a pressing force to the compact 10.

The pressing width W (the width of the pressing surface) refers to the width of the region where the outer surface 11Gf of the compact 10 is pressed, i.e., the distance in the direction orthogonal to the axial direction of the hole 12G and parallel to the outer surface 11Gf. The pressing width W may satisfy Gd×1/3≤W≤Gd×2. If the pressing width W is Gd×1/3 or more, a sufficient pressing force can be applied to the outer surface 11Gf of the compact 10. If the pressing width W is Gd×2 or less, no excessive pressing force will act locally on the outer surface 11Gf of the compact 10. The pressing width W preferably satisfies Gd×4/9 or more, more preferably Gd×1/2 or more, even more preferably Gd×2/3 or more, particularly preferably Gd×1 or more. The pressing width W also preferably satisfies Gd×1.8 or less, particularly preferably Gd×1.5 or less. It is preferred that the center of the pressing width W be located on an imaginary line C passing through the center of the hole 12G and parallel to the thickness Gt direction of the thin portion 11G. That is, it is preferred that the lengths L from the imaginary line C to both ends of the pressing width W be equal (pressing width W/2).

(Drill)

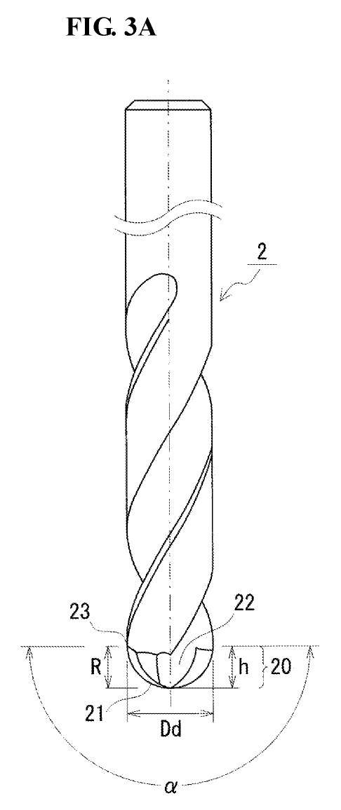

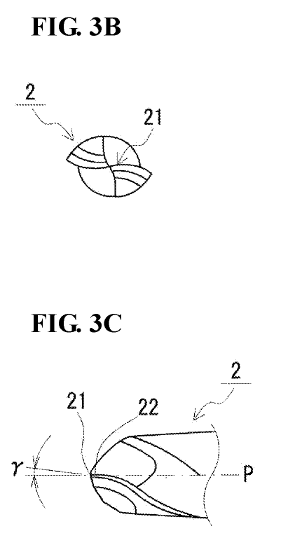

Although the drill 2 used may be appropriately selected, a drill including an end portion 20 having an arc-shaped cutting edge 21 (hereinafter “R-drill”) is suitable for use (FIGS. 3A, 3B, and 3C). FIG. 3A is a schematic plan view of the drill 2. FIG. 3B is a schematic front view of the drill 2 as viewed from the end portion thereof. FIG. 3C is a schematic side view partially showing the end portion 20 of the drill 2. The R-drill exerts little stress on the compact 10 so as to widen the hole 12G. In addition, when a through-hole is formed, edge chipping is unlikely to occur at the edge of the exit of the through-hole. The length h of the end portion 20 of the drill 2 in the axial direction is equal to the radius R of the arc. The end portion 20 refers to the portion from the leading end (apex) to the outer corner 23 of the cutting edge 21.

<Shape of Cutting Edge>

As shown in FIG. 3A, the projected shape of the cutting edge 21 of the drill 2 is arc-shaped as viewed in the direction parallel to the short sides of a rectangle having a diagonal that is a straight line passing through the chisel edge and joining both outer ends of the cutting edge 21 (outer corner 23). When this drill 2 is rotated and the cutting edge 21 is viewed in a direction orthogonal to the axis of rotation of the drill 2, the path of rotation of the cutting edge 21 appears arc-shaped. The arc defining the projected outline of the end portion 20 forming the cutting edge 21 has a central angle a of, for example, 130° or more, preferably from 135° to 180°, more preferably 150° or more. In this example, the arc has a central angle α of 180°. The radius R of the arc forming the cutting edge 21 is, for example, from 0.4 times to 0.6 times the diameter Dd of the drill 2, preferably equal to 0.5 times the drill diameter Dd, i.e., half the drill diameter Dd (d/2).

In this example, the cutting edge 21 is semicircular, with the central angle a of the arc being 180° and the radius R of the arc being equal to half the drill diameter Dd. The diameter Dd of the drill 2 is, for example, but not limited to, from 1.0 mm to 20.0 mm. As used herein, “the diameter of the drill (drill diameter)” refers to the outer diameter of the portion where the cutting edge is formed (i.e., the cutting portion).

<Rake Angle of Cutting Edge>

The cutting edge 21 has a rake angle of, for example, 0° or more, preferably from more than 0° to 10°, more preferably from 5° to 8°. As shown in FIG. 3C, the rake angle of the cutting edge 21 refers to the angle y made by a plane P parallel to the axis and a rake face 22 defining the cutting edge 21 as viewed in the direction parallel to the long sides of a rectangle having a diagonal that is a straight line passing through the chisel edge and joining both outer ends of the cutting edge 21 (outer corner 23). In this example, the cutting edge 21 has a rake angle of 7°.

A plurality of drills may be used. For example, different drills may be used for processing on the entrance and exit sides of the hole 12G. Specifically, a candle-shaped drill may be used for processing on the entrance side of the hole 12G, whereas the R-drill described above may be used for processing on the exit side of the hole 12G. The candle-shaped drill is unlikely to cause edge chipping at the edge of the entrance of the hole 12G. The candle-shaped drill refers to a drill including an end portion that is candle-shaped in the center thereof, that has a predetermined angle between straight lines joining the center of the end portion and both outer ends (outer corner) of the cutting edge (on the rear side of the drill), and that has recesses (e.g., arc-shaped) formed between the center and the outer ends. The predetermined angle may be, for example, from about 140° to about 220°. This candle-shaped drill may be a known candle-shaped drill.

(Processing Conditions)

The rotational speed and feed speed of the drill 2 may be appropriately set depending on the thickness Gt of the thin portion 11G and the size (diameter Gd and length GL) of the hole 12G. The rotational speed and feed speed of the drill 2 can be made high enough to be suitable for mass production. The rotational speed of the drill 2 may be, for example, 4,000 rpm or more, or 6,000 rpm or more, particularly 10,000 rpm or more. The feed speed of the drill 2 may be, for example, 700 mm/min or more, 800 mm/min or more, or 1,600 mm/min or more, particularly 2,000 mm/min or more.

[Sintering Step]

In the sintering step, the compact 10 cut as described above is sintered. Sintering may be performed with an appropriate sintering furnace (not shown). As the sintering temperature, the temperature required for sintering depending on the material of the compact 10 may be appropriately selected, for example, 1,000° C. or higher, or 1,100° C. or higher, particularly 1,200° C. or higher. The sintering time may be from about 20 minutes to about 150 minutes.

A sintered component 1 is obtained by sintering (the lower part of FIG. 1). The sectional view of the sintered component 1 on the right of the lower part of FIG. 1 is a sectional view taken along line (C)-(C) in the overall perspective view on the left of the lower part of the same figure. This sintered component 1 has a hole 12S formed therein and includes a thin portion 115 where the thickness St between the inner circumferential surface 12Si of the hole 12S and the outer surface 11Sf of the sintered component 1 is smaller than the diameter Sd of the hole 12S. There is no damage such as cracks in the outer surface 11Sa of the thin portion 11S. The outer surface 11Sa of the thin portion 11S refers to the region of the outer surface 11Sf (end surface) of the sintered component 1 where the hole 12S is projected in the axial direction of the sintered component 1 (indicated by hatching in the overall perspective view on the left of the lower part of FIG. 1). Although the sintered component 1 becomes smaller in size than the compact 10 after sintering, the relationship between the thickness St of the thin portion 11S of the sintered component 1, the diameter Sd of the hole 12S, and the length SL of the hole 12S in the axial direction is similar to the relationship between the thickness Gt of the thin portion 11G of the compact 10, the diameter Gd of the hole 12G in the compact 10, and the length GL of the hole 12G in the axial direction. This is because the thickness St of the thin portion 11S of the sintered component 1, the diameter Sd of the hole 12S, and the length SL of the hole 12S in the axial direction depend on the thickness Gt of the thin portion 11G of the compact 10, the diameter Gd of the hole 12G in the compact 10, and the length GL of the hole 12G in the axial direction, respectively.

[Use]

The method for manufacturing a sintered component according to the embodiment is suitable for use in the manufacture of various general structural components (sintered components such as mechanical components such as sprockets, rotors, gears, rings, flanges, pulleys, and bearings).

[Advantageous Effects]

The method for manufacturing a sintered component according to the embodiment provides the following advantages.

(1) A sintered component 1 without a flaw such as a crack in the outer circumferential surface of the thin portion 115 is obtained. Pressing the outer surface 11Gf of the compact 10 in the drilling step reduces the widening of the thin portion 11G outward of the hole 12G due to a stress exerted by the drill 2 so as to widen the hole 12G outward. This facilitates formation of a hole without a flaw such as a crack in the compact 10 even though the compact 10 has a lower hardness and is more brittle than the sintered component 1. Thus, a compact 10 without a flaw in the outer surface of the thin portion 11G is obtained. Since the surface properties of the sintered component 1 remain substantially the same as the surface properties of the compact 10, a sintered component 1 without a flaw in the outer surface 11Sa of the thin portion 11S is obtained by sintering a compact 10 without a flaw in the outer surface of the thin portion 11G.

(2) The productivity of the sintered component 1 can be improved. This is because the widening of the thin portion 11G of the compact 10 outward of the hole 12G during drilling can be reduced and therefore the processing speed of the compact 10 can be easily increased.

(3) The decrease in the life of the drill 2 can be reduced. This is because the drilling time can be shortened and therefore the processing load on the drill 2 can be easily reduced.

### Test Example 1

Compacts having through-holes formed therein by drilling to form thin portions were fabricated and examined for the presence or absence of flaws such as cracks in the outer surfaces of the thin portions.

[Sample Nos. 1-1 to 1-6]

Compacts of Sample Nos.1-1 to 1-6 were fabricated through the compaction step and the drilling step of the method for manufacturing a sintered component described above.

[Compaction Step]

A starting powder was prepared by providing a water-atomized iron powder (D50: 100 nm), a water-atomized copper powder (D50: 30 μm), a carbon (graphite) powder (D50: 20 μm), and ethylenebisstearamide, serving as a lubricant, and mixing them together.

The starting powder was then charged into a predetermined compaction mold for forming the cylindrical compact 10 as shown in FIG. 1 and was press-compacted at a press pressure of 600 MPa to form a compact having a thickness of 7 mm (inner diameter: 20 mm, outer diameter: 34 mm) and a length of 20 mm in the axial direction. This compact had a density of 6.9 g/cm³. This density was calculated as the apparent density from the size and the mass.

[Drilling Step]

Three through-holes were then formed in the compact with a drill to form three thin portions. The through-holes were formed by drilling the compact from the outer circumferential surface toward the central axis of the compact. The through-holes had a diameter Gd of 3.2 mm and a length GL of 7 mm. The thin portions had a thickness Gt of 1.5 mm. The three through-holes were formed at equal distances in the circumferential direction of the outer circumferential surface of the compact. This was performed while the compact was held by a chuck substantially in the centers between adjacent through-holes of the three through-holes to be formed.

Drilling was performed while the outer surface of the compact was pressed with the pressing member 3 as shown in FIG. 2. The pressing length was equal to the length GL of the through-holes, i.e., 7 mm (the length over the entire length of the through-holes). The pressing width (mm) and the pressing force (kg) were varied as shown in Table 1. The pressing width was defined as the width of the region where the outer surface of the compact was pressed, i.e., the distance in the direction orthogonal to the axial direction of the through-holes and parallel to the outer surface. The center of the pressing width was located on an imaginary line passing through the center of the through-holes and parallel to the thickness direction of the thin portions.

The drill used was an R-drill including an end portion having an arc-shaped cutting edge as shown in FIG. 3A. The R-drill had a drill diameter Dd of 3.2 mm, and the arc defining the projected outline of the end portion forming the cutting edge had a central angle α of 180° and a radius R of 1.6 mm (1/2 times the drill diameter Dd). The cutting edge had a rake angle of 7°. This R-drill was fabricated by polishing the cutting edge at the end portion of a drill manufactured by Sumitomo Electric Hardmetal Corp. (model: MDW0800GS4, material: cemented carbide).

The rotational speed of the drill and the feed speed of the drill (entrance feed speed and main feed speed) were varied as shown in Table 1. The entrance feed speed refers to the speed until the area near the entrance (3 mm from the outer circumferential surface of the compact) was cut, whereas the main feed speed refers to the speed thereafter and until the exit was opened.

[Cracking Evaluation]

The outer surfaces of the individual thin portions formed by forming the individual through-holes were examined for the presence or absence of cracks by surface observation and magnetic particle inspection. Magnetic particle inspection was performed by magnetizing a compact immersed in a fluorescent liquid containing a magnetic powder and irradiating the compact with ultraviolet light from an ultraviolet lamp (black light). Cracks appeared as bright streaks. The results are summarized in Table 1. “Cracked” in Table 1 means that a crack formed in at least one of the three outer surfaces, whereas “not cracked” in Table 1 means that no crack formed in any of the three outer surfaces.

TABLE 1

| | | | | Pressing | | | Thickness |
|---|---|---|---|---|---|---|---|
| | Feed speed | | | member | | | Gt of |
| | Entrance | Main | Rotational | | Pressing | Cracks | Thin |
| Sample | feed speed | feed speed | speed | Width | force | Cracked or | Portion |
| No. | mm/min | mm/min | rpm | mm | kg | not cracked | mm |
| 1-1 | 700 | 700 | 10000 | 0.9 | 40 | Cracked | 1.5 |
| 1-2 | 700 | 700 | 10000 | 1.5 | 40 | Not cracked | 1.5 |
| 1-3 | 700 | 700 | 10000 | 4.8 | 40 | Not cracked | 1.5 |
| 1-4 | 700 | 700 | 10000 | 5.5 | 40 | Not cracked | 1.5 |
| 1-5 | 700 | 700 | 10000 | 7.0 | 40 | Cracked | 1.5 |
| 1-6 | 700 | 700 | 10000 | 10.0 | 40 | Cracked | 1.5 |

As shown in Table 1, none of the compacts of Sample Nos.1-2 to 1-4 had a flaw such as a crack formed in the outer surface of any thin portion. The compacts of Sample Nos. 1-1, 1-5, and 1-6 had a crack formed in the outer surface of any thin portion. These results demonstrate that a compact without a crack can be fabricated by pressing the outer surface of the compact at a particular width in a region extending over the entire length of a through-hole. In particular, a compact without a crack can be stably fabricated under the conditions for Sample Nos. 1-2 to 1-4.

Through-holes were formed in a compact in the same manner as, for example, Sample No.1-1 except that a candle-shaped drill (ZH342-ViO manufactured by Ryocoseiki Co., diameter: 3.2 mm) was used and the outer surface of the compact was not pressed. In this case, it was impossible to stably fabricate a compact without a crack as compared to Sample Nos. 1-2 to 1-4.

The present invention is not limited to these examples, but is indicated by the claims, and all changes that come within the meaning and range of equivalency of the claims are intended to be embraced therein.

### REFERENCE SIGNS LIST

1 sintered component

10 compact
11G, 11S thin portion
11Gf, 11Sf, 11Sa outer surface
12G, 12S hole
12Gi, 12Si inner circumferential surface

2 drill
20 end portion
21 cutting edge
22 rake face
23 outer corner

3 pressing member

1. A method for manufacturing a sintered component, comprising:
a compaction step of press-compacting a starting powder comprising a metal powder to form a compact;
a drilling step of forming a hole in the compact with a drill to form a thin portion where a thickness between an inner circumferential surface of the hole and an outer surface of the compact is smaller than a diameter of the hole; and
a sintering step of sintering the compact after the drilling step,
wherein the drilling step is performed while the outer surface of the compact is pressed in a region extending over an entire length of the hole in an axial direction, and wherein a width of the region where the outer surface of the compact is pressed is from 1/3 times to twice the diameter of the hole.

2. The method for manufacturing a sintered component according to claim 1, wherein the drill includes an end portion having an arc-shaped cutting edge.
